(19) United States
(12) Patent Application Publication
(10) Pub. No.: US 2013/0060723 A1
(43) Pub. Date: Mar. 7, 2013

(54) METHOD AND SYSTEM FOR A SMART AGENT FOR INFORMATION MANAGEMENT WITH FEED AGGREGATION

(71) Applicant: Juan Pablo Di Lelle, Montreal (CA)

(72) Inventor: Juan Pablo Di Lelle, Montreal (CA)

(73) Assignee: Spundge inc., Montreal (CA)

(21) Appl. No.: 13/605,794

(22) Filed: Sep. 6, 2012

Related U.S. Application Data
(60) Provisional application No. 61/531,564, filed on Sep. 6, 2011.

(51) Int. Cl. G06F 15/18

(52) U.S. Cl. 706/12

(57) ABSTRACT

The present document describes a system and method for managing electronic information. The system may include an input adapted to receive a search topic from a remote user device over a communication network, and a smart agent module configured to perform a semantic analysis on the topic to generate a set of filter parameters. The system may then to collect electronic information about the search topic from at least one remote electronic information source over the communication network, and filter the collected information using the set of filter parameters to produce a stream of filtered information. The filtered information may then be packaged in discrete information containers and sent to the user device for display.

### CROSS-REFERENCE TO RELATED APPLICATIONS

This application claims priority of U.S. provisional patent application 61/531564 filed on Sep. 6, 2011. The specification is hereby incorporated by reference in their entirety.

### BACKGROUND

(a) Field

The subject matter disclosed generally relates to the field of electronic information management; more specifically it relates to the aggregation, organization, display and use of disparate electronic information feeds to create electronic notebooks and user generated content.

(b) Related Prior Art

There are many news aggregation sites on the web which collect, organize and display news feeds from around the world. These sites specialize in making syndicated web content such as news articles, blogs, vlogs and podcasts from around the world available to the general public in a single web location. The content is displayed as links to the original content and users navigate through the links to view the content that interests them. While these links to content can be saved or bookmarked, there lacks a simple and intuitive method for the viewer to collect, save and organize the content itself within an integrated search system.

On the other hand, many sites on the internet offer news or information feeds in the form of RSS feeds or something similar. These sites are sources of information which broadcast copious amounts of information on a daily basis. What is needed is a smart agent that can be trained to help collect, filter, and organize and display these disparate feed formats in one platform and in a concise manner. A system and a method for an independent smart agent is needed that can work without the user's direct involvement in every decision.

Furthermore, while current news aggregation sites allow for commenting and sharing of stories via email or twitter or the like, they don't offer the ability for a user to truly get into the discussion by writing their own story. Current sites are mostly a one way funnel of information towards the user, there is a lack of smart agents that can help users to aggregate information and create their own story and distribute that story for other users to see.

### SUMMARY

According to an embodiment, there is provided a method for managing electronic information using an automated smart agent provided embedded in a server, the method comprising: receiving a search topic from a remote user device over a communication network; performing a semantic analysis on the search topic to generate a set of filter parameters; collecting electronic information about the search topic from at least one remote electronic information source over the communication network; filtering the collected information using the set of filter parameters to produce a stream of filtered information; packaging the filtered information in discrete information containers; sending the discrete information containers to the remote user device for display.

According to another embodiment, the method further comprises: training the smart agent including monitoring changes performed by a user to output results proposed by the automated smart agent.

According to a further embodiment, the output results comprise one or more of: filter parameters, and information sources.

According to yet another embodiment, the method further comprises storing the filtered information in a database.

According to another embodiment, the method further comprises updating the database with new filtered information.

According to a further embodiment, the method further comprises: training the smart agent including comparing information stored in the database with the new filtered information to eliminate duplicates.

According to yet another embodiment, training the automated smart agent further comprises modifying the filter parameters to avoid duplicates.

According to another embodiment, the updating is performed in real time as new information is posted in the information sources.

According to a further embodiment, the updating is performed at a rate that is dependent on an output rate of information from the at least one remote electronic information source and a restrictiveness of the filter parameters.

According to yet another embodiment, the method further comprises creating a notebook which is empty; organizing the filtered electronic information related to the search topic in the notebook.

According to another embodiment, the method further comprises abbreviating the filtered electronic information of each information container in an information bubble thereby resulting in a list of information bubbles within the notebook.

According to a further embodiment, the method further comprises: receiving a user input representing an acceptance or rejection of one of the information bubbles in the notebook; updating the notebook in accordance with the user input.

According to yet another embodiment, the method further comprises: training the smart agent including comparing the stream of filtered information, with the rejected information bubbles and the accepted information bubbles.

According to another embodiment, the method further comprises: receiving a user selection of information from an information source; and adding the selected information in an information bubble in the notebook.

According to another embodiment, there is provided a system for managing electronic information over a communication network using an automated smart agent provided embedded in a server, the system comprising: an input adapted to receive a search topic from a remote user device over a communication network; a smart agent module configured to perform a semantic analysis on the search topic to generate a set of filter parameters; a processor having access to statements and instructions which when executed cause the processor to collect electronic information about the search topic from at least one remote electronic information source over the communication network, and filter the collected information using the set of filter parameters to produce a stream of filtered information; a memory for packaging the filtered information in discrete information containers; an output for sending the discrete information containers to the remote user device for display.

According to a further embodiment, the automated smart agent is trained by monitoring changes performed by a user to output results proposed by the automated smart agent.

According to yet another embodiment, the automated smart agent is trained by comparing information stored in a database with new information arriving at the system and output by the filters.

According to another embodiment, the system is adapted to creating a notebook which is empty for the search topic and organizing the filtered electronic information related to the search topic in the notebook.

According to a further embodiment, the system abbreviates the filtered electronic information of each information container in an information bubble thereby resulting in a list of information bubbles within the notebook.

According to yet another embodiment, the system is adapted to receive a user input representing an acceptance or rejection of one of the information bubbles in the notebook; wherein the automated smart agent is trained by comparing the stream of filtered information, with the rejected information bubbles and the accepted information bubbles.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a flowchart of a method for information gathering in accordance with an embodiment;

FIG. 2a is a flow chart for smart notebook creation and use in accordance with another embodiment;

FIG. 2b is an example of a visual display of a notebook in accordance with another embodiment;

FIG. 3 illustrates an exemplary diagram of a semantic flow of a notebook agent in training in accordance with another embodiment;

FIG. 4 illustrates an exemplary diagram of a semantic flow of a notebook agent operating in smart agent mode in accordance with another embodiment;

FIG. 5 illustrates a user that would browse the web and find a web page with content that they wished to convert into an information bubble in accordance with another embodiment.

FIGS. 6a and 6b illustrates that the agent can make a decision and place the information bubble in a notebook, or alternatively that the user can choose to manually place the information bubble in one of the suggested notebooks in accordance with other embodiments;

FIG. 7a illustrates a dashboard in accordance with an embodiment;

FIG. 7b illustrates a dashboard in accordance with an embodiment;

FIG. 7c illustrates a dashboard in accordance with an embodiment;

FIG. 8 is a flowchart of a method for managing electronic information using an automated smart agent provided embedded in a server in accordance with another embodiment;

FIG. 9 illustrates a computing environment that includes one or more client machines in communication with servers in accordance with another embodiment; and

FIG. 10 illustrates a computing device, where the client machine and server illustrated in FIG. 9 can be deployed as and/or executed on any embodiment of the computing device.

It will be noted that throughout the appended drawings, like features are identified by like reference numerals.

### DETAILED DESCRIPTION

The present embodiments describe a system and method for managing electronic information. The system may include an input adapted to receive a search topic from a remote user device over a communication network, and a smart agent module configured to perform a semantic analysis on the topic to generate a set of filter parameters. The system may then to collect electronic information about the search topic from at least one remote electronic information source over the communication network, and filter the collected information using the set of filter parameters to produce a stream of filtered information. The filtered information may then be packaged in discrete information containers and sent to the user device for display.

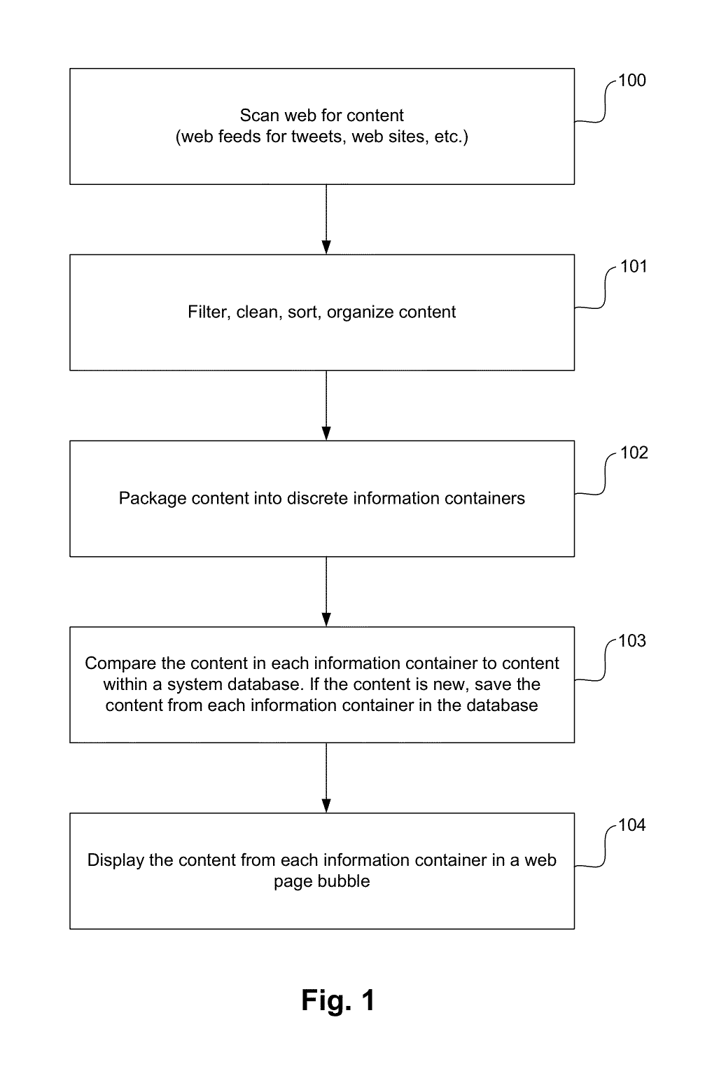

FIG. 1 is a flowchart of a method for information gathering in accordance with an embodiment. The method begins at step 100 by gathering information related to a topic from the web by querying web sites for their web feed information. This information can come from many different sources such as, but not limited to, news sites, magazine sites, blogs, vlogs, twitter, facebook and the like. Any web site that provides a feed can be a source. Most feeds on the internet use either the RSS or ATOM format, which are standard web syndication formats, however, the methodology herein can work with any feed format. The content of the information can be in the form of text, images, sound, video or any combination thereof.

Step 101 includes filtering, processing and organizing the gathered information. Step 102 includes cleaning, reformatting and categorizing or sorting the gathered information and organizing it into discrete information containers (aka information bubbles). After organizing into discrete information containers the data representing the information is compared (103) to saved data in a database, referred to herein as the system database. The saved data represents stored information containers that were saved previously. The comparison is an attempt to eliminate duplication of the content within information containers. If the content with the gathered information containers match the contents of a saved information container, then the gathered information container is discarded; otherwise it is saved in the database. Subsequent gathering of information searches both the web and the system database. If the gathered information containers have new content and they are saved to the database, the content within the information containers is also displayed on an electronic display (104). The displayed information containers are referred to as information bubbles throughout the description herein. The information bubbles show an abridged version of the total information content such as at least one of the following: a title or partial title, a picture or partial picture, a body of text or a partial section of the body of text. Clicking on the information bubble with a mouse will allow access to the full content of the bubble displayed by either expanding the bubble or by displaying the content in a new web page.

### Smart Electronic Notebooks:

In an embodiment, there is provided an agent assisted electronic notebook which represents a curation tool and repository for information bubbles related to a topic. The electronic notebook allows for information bubbles to be discovered and saved in an organized way. An electronic notebook comprises at least three components: a content filter, a stream of filtered content in the form of information bubbles, and a repository for saved content in the form of information bubbles. For the purposes of the description herein, the stream of filtered content in the form of information bubbles will be referred to as a notebook stream. The notebook stream can be displayed on an electronic display device. For the purposes of the description herein, the repository for saved content in the form of information bubbles will be referred to as notebook content. The notebook content can be displayed on an electronic display device.

In an embodiment, the smart electronic notebooks described herein use semantic analysis. Semantic analysis is known to those familiar with the art. A typical semantic analysis can extract relevant keywords, or descriptions or other information from an initial text. The extracted information is representative of the initial text and can be used to generate filter parameters for finding new content that is related to the initial text. Or the extracted information can be used to compare the initial text to other texts to determine the relatedness of the two texts. In other words the similarity of two texts or two sets of information can be determined with a semantic analysis.

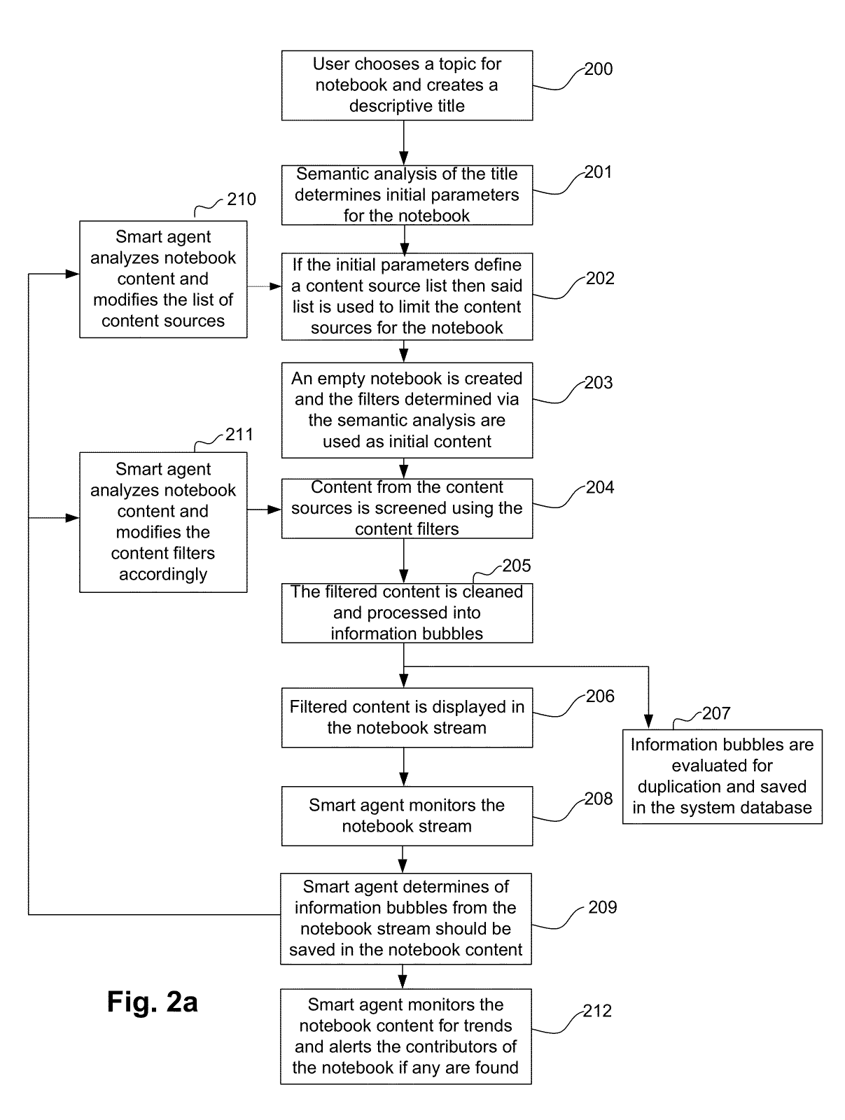

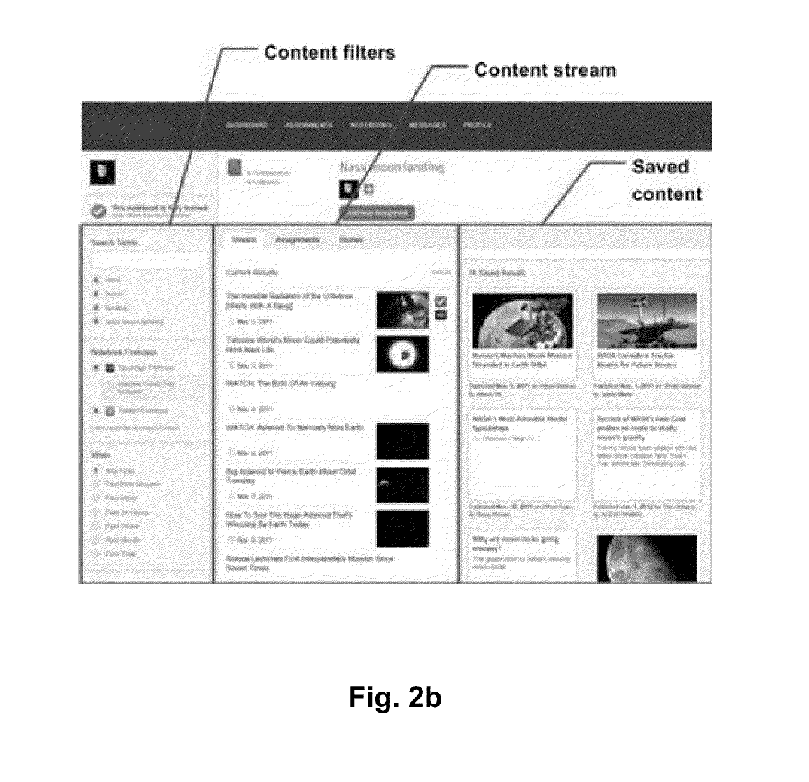

FIG. 2a is a flow chart for smart notebook creation and use, in accordance with an embodiment. A notebook and its parameters can be created by providing only a descriptive title for the notebook. A semantic analysis on the title provides relevant initial filter parameters for the notebook. First a user decides to create a notebook based around a topic and then chooses a descriptive title for it (step 200). A semantic analysis (step 201) is performed on the title to determine a set of notebook parameters. These notebook parameters help to define the notebook and can be used to find content to populate it. The notebook parameters can contain, but are not limited to, content filters and content source filters. If the notebook parameters define a content source list then the list is used to limit the content sources for the notebook (step 202).

An empty notebook is created and the content filters are used as an initial set of filters (step 203). The content filters are filters that can be used to filter content in order to find content related to the topic of the notebook. The filters can include many different types such as, but not limited to, keywords, location, information sources (websites), time, social engagement, language and relevance. The notebook then uses the filter parameters to filter streams of content coming from the internet or from a database (step 204). The content that passes through the filter is then cleaned and processed (step 205) and displayed for the user in information bubbles in the notebook stream (step 206).

The information bubbles are then sent to the system database for storage. In an embodiment, before being stored the information bubbles will be evaluated for duplication with respect to the content already in the system database. If the information bubbles are determined to be or to include new content the new content may then be added to the system database (step 207). The notebook agent monitors the notebook stream (step 208). The notebook agent determines if information bubbles from the notebook stream should be saved in the notebook content (step 209). The notebook agent monitors the notebook content and the notebook stream to determine if the notebook owners or contributors should be alerted to the activity within the notebook (step 212).

In an embodiment, the notebook agent uses a semantic analysis on the changing notebook content to keep the content filters up to date and to modify the filters if they are not (step 211). The modified content filters will thus change the streamed content. Alternatively, the notebook agent can determine that the content sources must be modified (step 210). Note that there is a feedback loop where the notebook content affects the notebook filters, which affects the notebook stream and subsequently the notebook content. This cyclic action provides a positive feedback loop where the content stream becomes increasingly focused on the topic or changes as the topic evolves, for example if the topic relates to an an ongoing event.

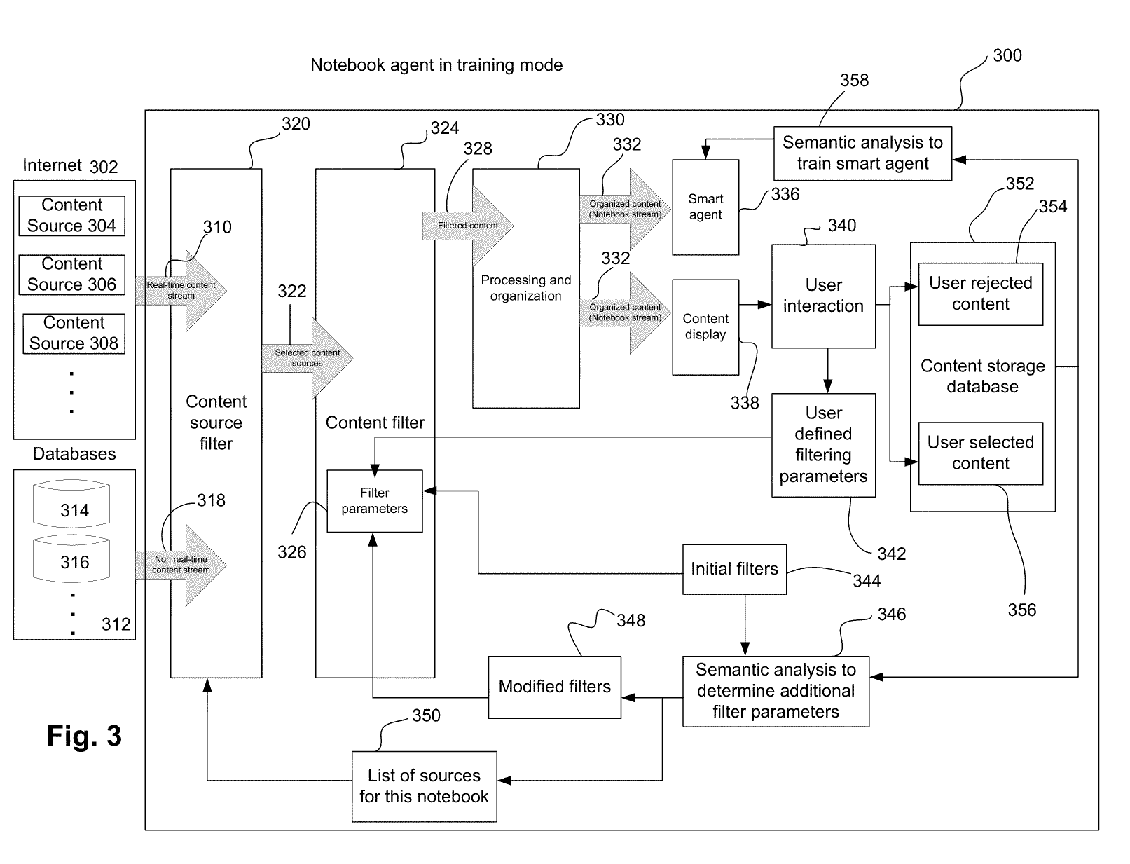

In an embodiment, the notebook agents may be trained by a user or by multiple users. FIG. 3 illustrates an exemplary diagram of a semantic flow of a notebook agent in training. The content filter (step 324) uses filter parameters (326) to filter the content within content streams from the web (302) or from databases (312). There may also be a source filter (320) before the content filter which can filter out entire groups of sources. The filtering parameters (326) are determined in several ways. When the notebook is first created, there is an initial set of filters (344) that can be given by the user or that can be determined by a semantic analysis of the title. The filtering parameters (326) can be modified at any time by a user (342). Also, the filtering parameters (326) can be modified by a semantic analysis (346) on the notebook content (354 and 356). The content (328) that passes through the filter is processed and organized (330) and makes it into the notebook stream (338). The notebook stream may be a real-time updated stream of content related to a given topic and defined by the filter parameters and displayed as a series of information bubbles. In an embodiment, the notebook stream is updated on an ongoing basis. The rate at which it is updated is dependent on the output rate of content from the sources (302 and 312) and the restrictiveness of the filters (320 and 324). Information bubbles in the notebook stream may be permanently saved in the notebook by manually selecting them (340) and placing them in the saved content (356). The rejected information bubbles (354) are also kept in the notebook database. The selected content (356), the rejected content (354) and the content stream (332) is used to train the smart notebook agent (336) that is responsible for automated selection of content from the notebook stream to the notebook database (352).

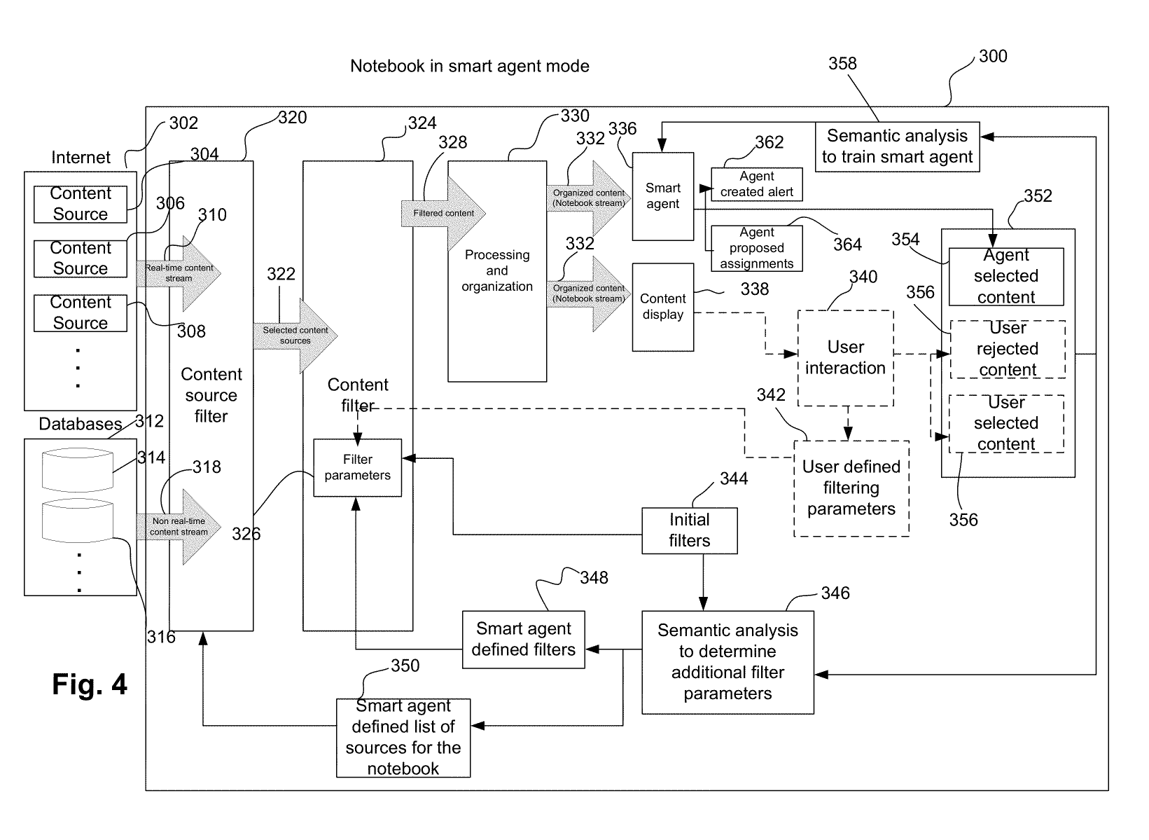

After the notebook is trained, the notebook can operate in autonomous smart agent mode where the choice of which information bubbles from the notebook stream are to be saved in the notebook is made by an automated smart agent. FIG. 4 illustrates an exemplary diagram of a semantic flow of a notebook agent operating in smart agent mode. When operating in the autonomous smart agent mode, the manual input (340, 342, 354 and 356) is optional as is shown with the dashed lines in the figure. In other words, manual input may be received but the system may work without it. In the autonomous mode, the smart agent (336) replaces the human user making choices (340). The smart agent (336) uses the semantic analysis (358) to select content (360) and add it to the notebook database (352). The smart agent (336) can also determine when an alert (362) should go out to the notebook owner or collaborator. An alert of this kind would go out when certain criteria were met; for example if a certain number of information bubbles were selected by the agent in a certain amount of time. This would suggest that perhaps some event had taken place. The alert might signal to a user that the notebook stream should be reviewed. Similarly, if certain criteria were met, the agent could send out an automated request for an assignment (364) perhaps requesting that a user write a story about the event that sparked the activity in the notebook.

In one embodiment, the visual display of a notebook is split into a plurality of sections with at least one section displaying saved content and at least one other section displaying the content stream. Optionally, it is also possible to display the content filters section which indicates the filters used to filter the content. An example of a visual display of a notebook is illustrated in FIG. 2b. As shown in the example of FIG. 2b, at least three operations can be done on the information bubbles within the content stream:
1. The information bubbles can be deleted and ignored by the notebook;
2. The information bubbles can be saved in a database used by a notebook and used to generate more search parameters while not being displayed in the notebook; and
3. The information bubbles can be saved in the database and displayed in the notebook and used to generate more search term parameters.

The smart electronic notebook 300 can be used in a collaborative real-time environment. In this aspect, the saved content of a notebook is accessible to all users (340) in a collaborative group. All the members of the collaborative group that share the collaborative notebook share many of the notebook's attributes. In this embodiment, the group shares a common content stream (332). Even though the content stream is common the stream can be displayed on independent display devices. The saved content (356) within the notebook is also common to all members of the collaborative group. However each member of the group can independently choose content to place in the notebook database (352). Once any one member of the group adds an information container to the saved content, all members of the group see an updated saved content field (356). In this collaborative way, all members of the group contribute to training the smart agent. Similarly, when the notebook is operating in autonomous agent mode, all members of the collaboration see the agent selected content (360) as it appears in the notebook database (352).

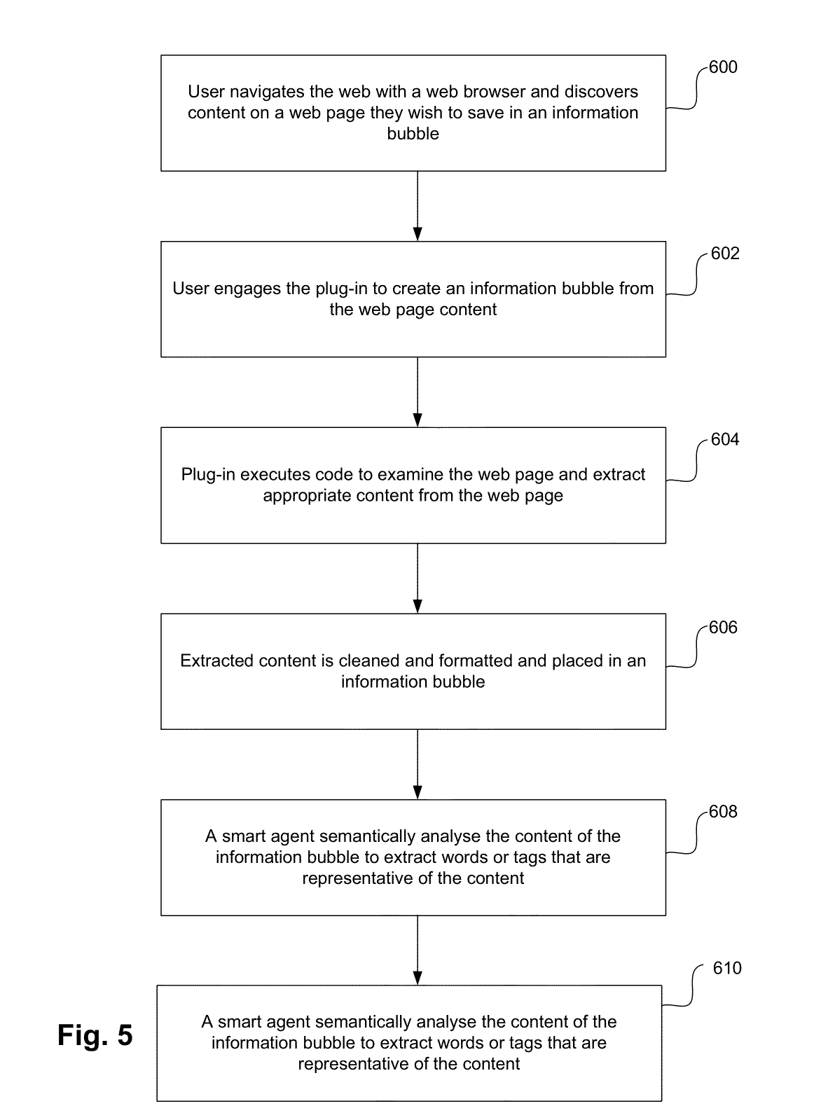

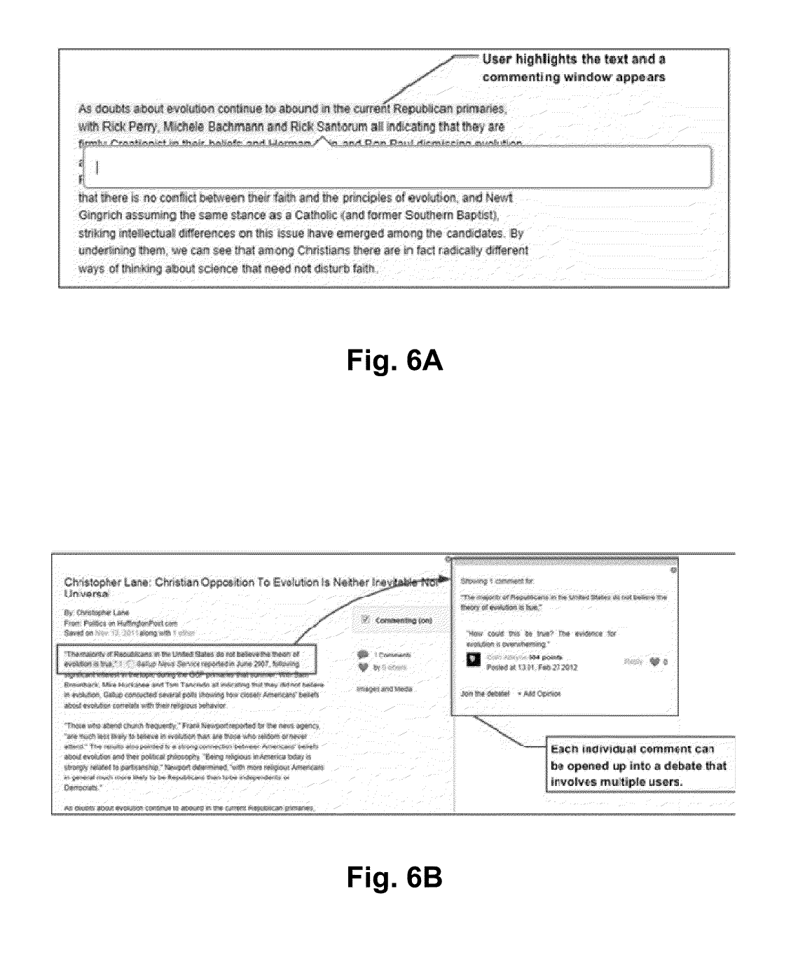

In a further aspect, an individual can automatically extract content from a web site and create a single information bubble with that information. Preferably this is embodied as a plug-in for a web browser. As shown in FIG. 5, a user would browse the web and find a web page with content that they wished to convert into an information bubble (step 600). The plug-in provides a button (step 602) for the user to click to convert the content on the web page to an information bubble. The plugin executes an algorithm (step 604) to analyze all the content on the web page as well as the formatting and structure of the page. The analysis determines what sections of the web page constitute the appropriate content for the information bubble. The extracted information is cleaned and organized and placed into an information bubble (step 606). An automated agent then performs a semantic analysis on the said information bubble and extracts some words or tags that are representative of the content (step 608). The smart agent compares (step 610) the extracted words or tags to similarly determined words or tags from the content within notebooks and suggests one or more notebooks as a potential match for the content. The agent can then make a decision and place the information bubble in a notebook, or alternatively the user can then choose to manually place the information bubble in one of the suggested notebooks. An example is shown in FIGS. 6a and 6b.

### Content Creation

Content can be created and added to the system database or broadcast on the web or syndicated on targeted 3rd party systems. A content creation editor allows a user to create content while simultaneously viewing information bubbles or notebooks that were selected by the smart notebook agent. The display for the editor is split into a plurality of sections with at least one section displaying the editor and at least one other section displaying saved content (360 and 356) that could have been saved by the smart agent or the live stream of content (322) that might have been generated using filters determined by the smart agent. The said saved content can be one notebook, or a group of notebooks or single bubble, or a group of bubbles or similar grouping of saved content.

Content can also be created within the framework of an assignment system. The assignment system is a system whereby content creation is tracked. An assignment is a request for content creation given to a user as a task or duty. An assignment can be created and given to oneself, or to another user, or an assignment can be given by an automated agent. Assignments can also be ‘pitched’ to another user. A pitched assignment is an idea for an assignment that is sent from one user to another user or from an automated agent to a user. The user that receives the pitched assignment then has the option to accept the idea for an assignment and create the assignment and give that assignment to any user they choose. The progress or status of an assignment is tracked and each user involved in the assignment can receive status updates, as an email or other message notification if they choose to.

User may have followers of a one or more of their notebooks. When prescribing as follower, each follower may have access to the saved content of specific notebooks that they are following without being able to edit or modify the saved content of the followed notebook. The said saved content may have been generated by a smart agent.

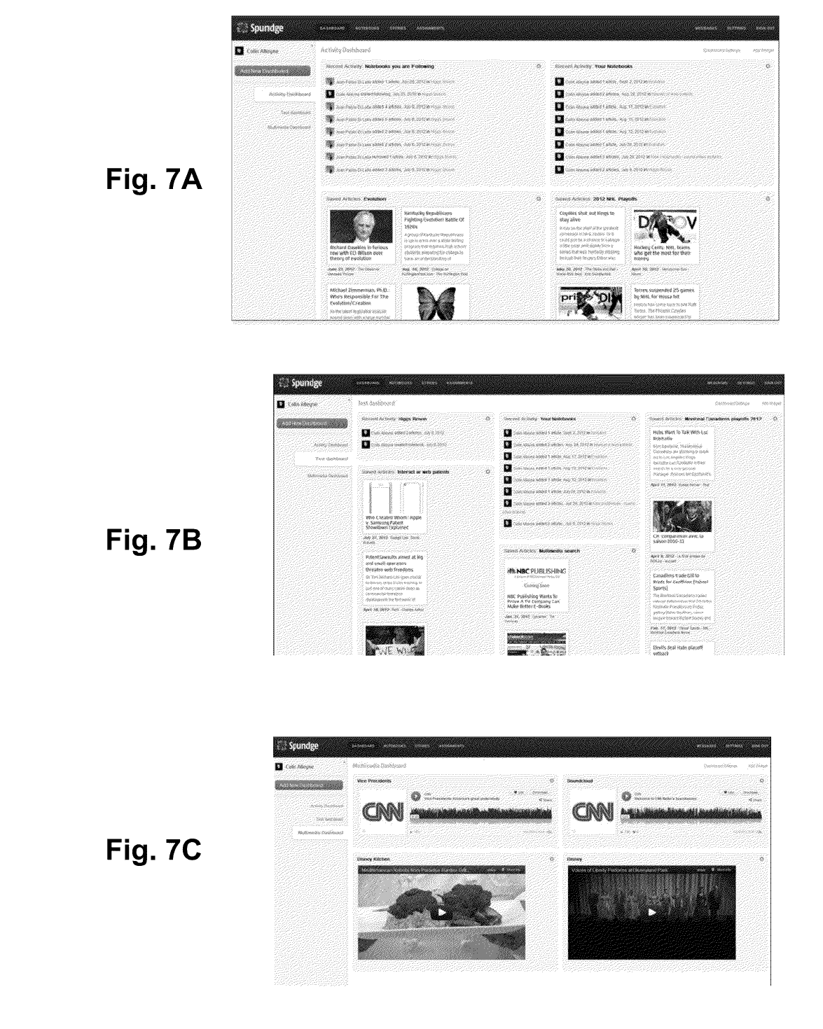

In an embodiment the notebook may include a dashboard notification of each entry of saved content and optionally a timestamp of the entry, a picture, text or a portion of the content. The dashboard can also include notifications of the addition or subtraction of followers to a notebook, and the creation or deletion of notebooks, and the addition or subtraction of assignments. The dashboard can also show activity in notebooks that a user is following or notebooks that a user is collaborating on. The dashboard may also be shared and made available for viewing by the other users. In an embodiment, entries in the dashboard may be provided in the form of widgets (windows or the like) that may be moved around on the screen within the dashboard. The entries may be updated in real time as more entries are added into the notebook. Examples of dashboards are included in FIGS. 7a to 7c.

In a further embodiment, the user may embed the content stream section or saved content section (or both) of a notebook in a website by embedding code or dragging the selected section and dropping it in the website. For example, the user may select a section of the notebook and embed it a Facebook page, or any website they choose. Whereby, when changes occur in the notebook, the changes may be reflected automatically in the website in which the content stream section or saved content section were embedded without user intervention.

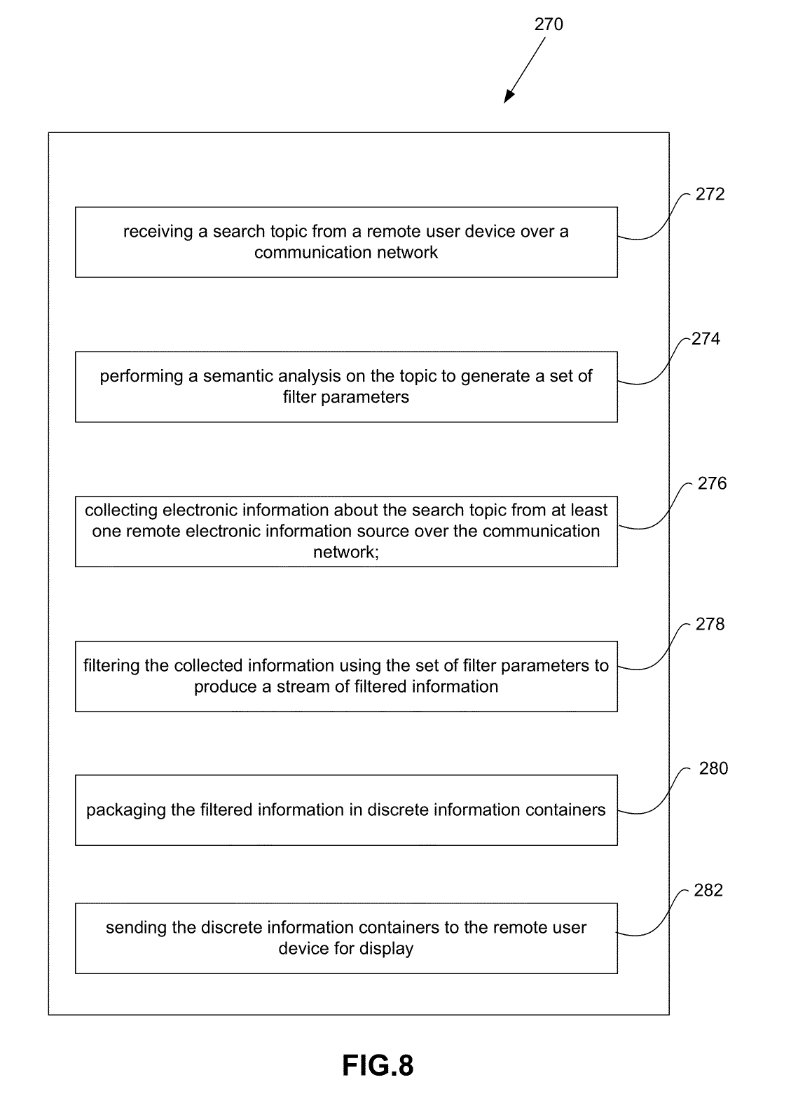

FIG. 8 is a flowchart of a method 270 for managing electronic information using an automated smart agent provided embedded in a server. The method begins at step 272 by receiving a search topic from a remote user device over a communication network. Step 274 comprises performing a semantic analysis on the topic to generate a set of filter parameters. Step 276 comprises collecting electronic information about the search topic from at least one remote electronic information source over the communication network. Step 278 comprises filtering the collected information using the set of filter parameters to produce a stream of filtered information. Step 280 comprises packaging the filtered information in discrete information containers. Step 282 comprises sending the discrete information containers to the remote user device for display.

### Hardware and Operating Environment

The embodiments may be implemented in a server accessed by users over a communication network using a website associated with the server. In an embodiment, an API (Application Program Interface) may be installed on different websites which are not associated with the server for transferring the search topic to the server and obtain search results to be presented on these different websites from the server. Details of an exemplary computing environment in which the embodiments may be practiced are provided below.

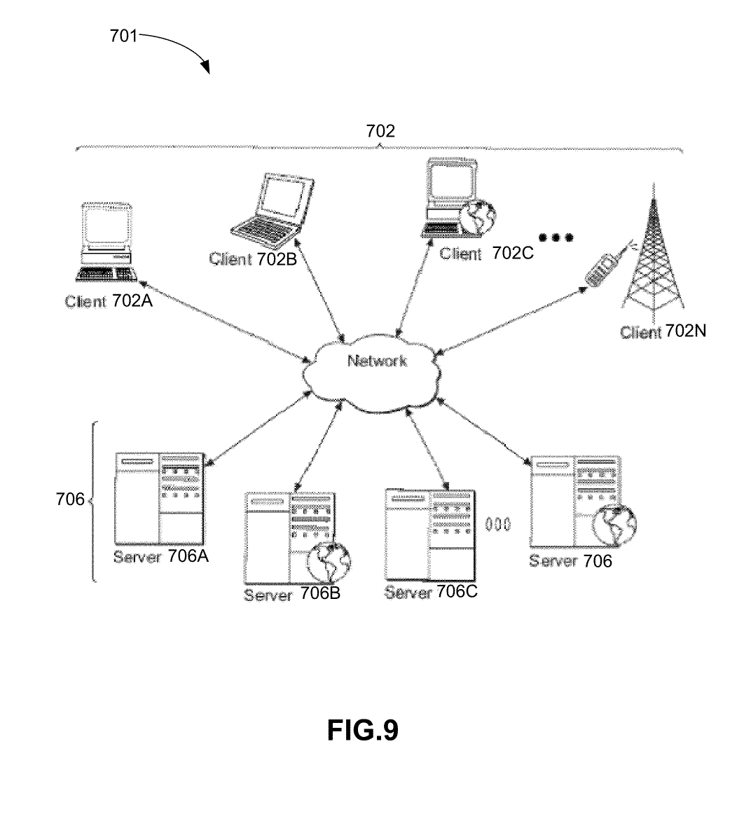

FIG. 9 illustrates one embodiment of a computing environment 701 that includes one or more client machines 702A-702N in communication with servers 706A-706N, and a network 704 installed in between the client machines 702A-702N and the servers 706A-706N. In some embodiments, client machines 702A-70N may be referred to as a single client machine 702 or a single group of client machines 702, while servers may be referred to as a single server 706 or a single group of servers 706. One embodiment includes a single client machine 702 communicating with more than one server 706, another embodiment includes a single server 706 communicating with more than one client machine 702, while another embodiment includes a single client machine 702 communicating with a single server 706.

A client machine 702 within the computing environment may in some embodiments, be referenced by any one of the following terms: client machine(s) 702; client computer(s); end-user's computer. It is also to be noted that a client machine may also function as a server and vice versa.

The client machine 702 can in some embodiments execute, operate or otherwise provide an application that can be any one of the following: software; a program; executable instructions; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other type and/or form of executable instructions capable of executing on client machine 702. Still other embodiments may include a computing environment 701 with an application that is any of either server-based or remote-based, and an application that is executed on the server 706 on behalf of the client machine 702. Further embodiments of the computing environment 701 include a server 706 configured to display output graphical data to a client machine 702 using a thin-client or remote-display protocol, where the protocol used can be any one of the following protocols: the Independent Computing Architecture (ICA) protocol manufactured by Citrix Systems, Inc. of Ft. Lauderdale, Fla.; or the Remote Desktop Protocol (RDP) manufactured by the Microsoft Corporation of Redmond, Wash.

In one embodiment, the client machine 702 can be a virtual machine 702C such as those manufactured by XenSolutions, Citrix Systems, IBM, VMware, or any other virtual machine able to implement the methods and systems described herein.

The computing environment 701 can, in some embodiments, include more than one server 706A-706N where the servers 706A-706N are: grouped together as a single server 706 entity, logically-grouped together in a server farm 706; geographically dispersed and logically grouped together in a server farm 706, located proximate to each other and logically grouped together in a server farm 706. Geographically dispersed servers 706A-706N within a server farm 706 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments the server farm 706 may be administered as a single entity or in other embodiments may include multiple server farms 706. The computing environment 701 can include more than one server 706A-706N grouped together in a single server farm 706 where the server farm 706 is heterogeneous such that one server 706A-706N is configured to operate according to a first type of operating system platform (e.g., WINDOWS NT, manufactured by Microsoft Corp. of Redmond, Wash.), while one or more other servers 706A-706N are configured to operate according to a second type of operating system platform (e.g., Unix or Linux); more than one server 706A-706N is configured to operate according to a first type of operating system platform (e.g., WINDOWS NT), while another server 706A-706N is configured to operate according to a second type of operating system platform (e.g., Unix or Linux); or more than one server 706A-706N is configured to operate according to a first type of operating system platform (e.g., WINDOWS NT) while more than one of the other servers 706A-706N are configured to operate according to a second type of operating system platform (e.g., Unix or Linux).

The computing environment 701 can in some embodiments include a server 706 or more than one server 706 configured to provide the functionality of any one of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server 706 configured to operate as an active direction; a server 706 configured to operate as application acceleration application that provides firewall functionality, application functionality, or load balancing functionality, or other type of computing machine configured to operate as a server 706. In some embodiments, a server 706 may include a remote authentication dial-in user service such that the server 706 is a RADIUS server. Embodiments of the computing environment 701 where the server 706 comprises an appliance, the server 706 can be an appliance manufactured by any one of the following manufacturers: the Citrix Application Networking Group; Silver Peak Systems, Inc; Riverbed Technology, Inc.; F5 Networks, Inc.; or Juniper Networks, Inc. Some embodiments include a server 706 with the following functionality: a first server 706A that receives requests from a client machine 702, forwards the request to a second server 706B, and responds to the request generated by the client machine with a response from the second server 706B; acquires an enumeration of applications available to the client machines 702 and address information associated with a server 706 hosting an application identified by the enumeration of applications; presents responses to client requests using a web interface; communicates directly with the client 702 to provide the client 702 with access to an identified application; receives output data, such as display data, generated by an execution of an identified application on the server 706.

The server 706 can be configured to execute any one of the following applications: an application providing a thin-client computing or a remote display presentation application; any portion of the CITRIX ACCESS SUITE by Citrix Systems, Inc. like the METAFRAME or CITRIX PRESENTATION SERVER; MICROSOFT WINDOWS Terminal Services manufactured by the Microsoft Corporation; or an ICA client, developed by Citrix Systems, Inc. Another embodiment includes a server 706 configured to execute an application so that the server may function as an application server such as any one of the following application server types: an email server that provides email services such as MICROSOFT EXCHANGE manufactured by the Microsoft Corporation; a web or Internet server; a desktop sharing server; or a collaboration server. Still other embodiments include a server 706 that executes an application that is any one of the following types of hosted servers applications: GOTOMEETING provided by Citrix Online Division, Inc.; WEBEX provided by WebEx, Inc. of Santa Clara, Calif.; or Microsoft Office LIVE MEETING provided by Microsoft Corporation.

In one embodiment, the server 706 may be a virtual machine 706B such as those manufactured by Citrix Systems, IBM, VMware, or any other virtual machine able to implement the methods and systems described herein.

Communication between the client machine 702 and either a server 706 or servers 706A-706N can be established via any of the following methods: direct communication between a client machine 702 and a server 706A-706N in a server farm 706; a client machine 702 that uses a program neighborhood application to communicate with a server 706a-706n in a server farm 706; or a client machine 702 that uses a network 704 to communicate with a server 706A-706N in a server farm 706. One embodiment of the computing environment 701 includes a client machine 702 that uses a network 704 to request that applications hosted by a server 706A-706N in a server farm 706 execute, and uses the network 704 to receive from the server 706A-706N graphical display output representative of the application execution.

The network 704 between the client machine 702 and the server 706 is a connection over which data is transferred between the client machine 702 and the server 706. Although the illustration in FIG. 9 depicts a network 704 connecting the client machines 702 to the servers 706, other embodiments include a computing environment 701 with client machines 702 installed on the same network as the servers 706. Other embodiments can include a computing environment 701 with a network 704 that can be any of the following: a local-area network (LAN); a metropolitan area network (MAN); a wide area network (WAN); a primary network 704 comprised of multiple sub-networks 704′ located between the client machines 702 and the servers 706; a primary public network 704 with a private sub-network 704′; a primary private network 704 with a public sub-network 704′; or a primary private network 704 with a private sub-network 704′. Still further embodiments include a network 704 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; a network 704 that includes a wireless link where the wireless link can be an infrared channel or satellite band; or any other network type able to transfer data from client machines 702 to servers 706 and vice versa to accomplish the methods and systems described herein. Network topology may differ within different embodiments, possible network topologies include: a bus network topology; a star network topology; a ring network topology; a repeater-based network topology; a tiered-star network topology; or any other network topology able transfer data from client machines 702 to servers 706, and vice versa, to accomplish the methods and systems described herein. Additional embodiments may include a network 704 of mobile telephone networks that use a protocol to communicate among mobile devices, where the protocol can be any one of the following: AMPS; TDMA; CDMA; GSM; GPRS UMTS; or any other protocol able to transmit data among mobile devices to accomplish the systems and methods described herein.

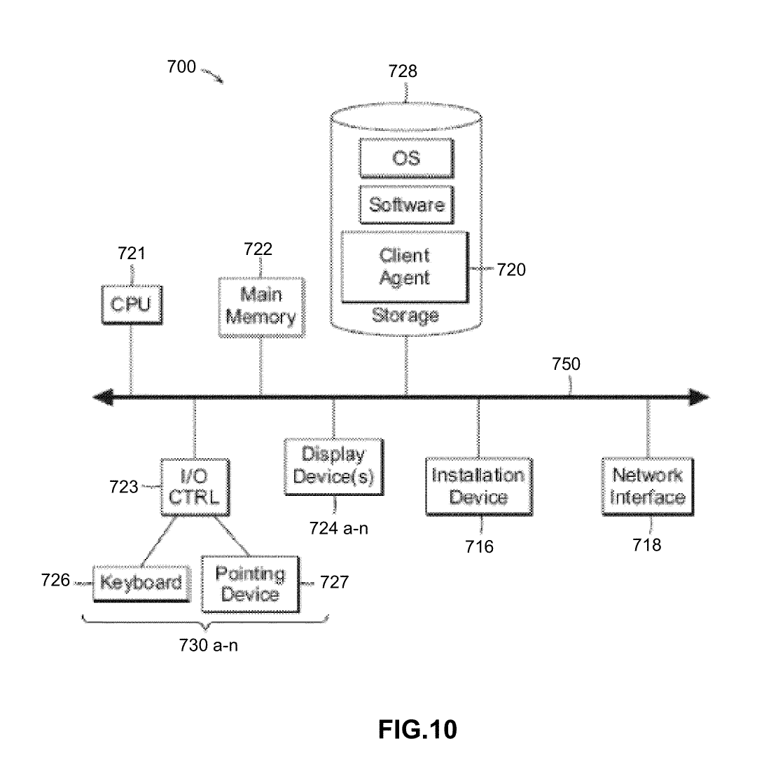

FIG. 10 illustrates an embodiment of a computing device 700, where the client machine 702 and server 706 illustrated in FIG. 9 can be deployed as and/or executed on any embodiment of the computing device 700 illustrated and described herein. The computing device 700 comprises a system bus 750 that communicates with the following components: a central processing unit 721; a main memory 722; storage memory 728; an input/output (I/O) controller 723; display devices 724A-724N; an installation device 716; and a network interface 718. In one embodiment, the storage memory 728 includes: an operating system, software routines, and a client agent 720. The I/O controller 723, in some embodiments, is further connected to a key board 726, and a pointing device 727. Other embodiments may include an I/O controller 723 connected to more than one input/output device 730A-730N.

Those skilled in the art will appreciate that the invention may be practiced with other browser/web-enabled computer system configurations, including hand-held devices, multiprocessor systems, microprocessor-based or programmable consumer electronics, network PCS, minicomputers, mainframe computers, and the like. The invention may also be practiced in distributed computing environments where tasks are performed by remote processing devices that are linked through a communications network. In a distributed computing environment, program modules may be located in both local and remote memory storage devices.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for managing electronic information using an automated smart agent provided embedded in a server, the method comprising:
receiving a search topic from a remote user device over a communication network;
performing a semantic analysis on the search topic to generate a set of filter parameters;
collecting electronic information about the search topic from at least one remote electronic information source over the communication network;
filtering the collected information using the set of filter parameters to produce a stream of filtered information;
packaging the filtered information in discrete information containers;
sending the discrete information containers to the remote user device for display.

2. The method of claim 1, further comprising:
training the smart agent including monitoring changes performed by a user to output results proposed by the automated smart agent, the monitoring including analyzing the changes performed by the user to create rules and/or algorithms and adopt the rules and algorithms in future processing.

3. The method of claim 2, wherein the output results comprise one or more of: filter parameters, information sources, and the choice of saved content.

4. The method of claim 1, further comprising storing the filtered information in a database.

5. The method of claim 4, further comprising updating the database with new filtered information.

6. The method of claim 5, further comprising:
training the smart agent including comparing information stored in the database with the new filtered information to eliminate duplicates.

7. The method of claim 6, wherein training the automated smart agent further comprises modifying the filter parameters to avoid duplicates.

8. The method of claim 5, wherein the updating is performed in real time as new information is posted in the information sources.

9. The method of claim 5, wherein the updating is performed at a rate that is dependent on an output rate of information from the at least one remote electronic information source and a restrictiveness of the filter parameters.

10. The method of claim 1, further comprising
creating a notebook which is empty;
organizing the filtered electronic information related to the search topic in the notebook.

11. The method of claim 10, further comprising
abbreviating the filtered electronic information of each information container in an information bubble thereby resulting in a list of information bubbles within the notebook.

12. The method of claim 11, further comprising:
receiving a user input representing an acceptance or rejection of one of the information bubbles in the notebook;
updating the notebook in accordance with the user input.

13. The method of claim 11, further comprising:
training the smart agent including comparing the stream of filtered information, with the rejected information bubbles and the accepted information bubbles to create and algorithms for the smart agent.

14. The method of claim 10, further comprising:
receiving a user selection of information from an information source; and
adding the selected information in an information bubble in the notebook.

15. A system for managing electronic information over a communication network using an automated smart agent provided embedded in a server, the system comprising:
an input adapted to receive a search topic from a remote user device over a communication network;
a smart agent module configured to perform a semantic analysis on the search topic to generate a set of filter parameters;
a processor having access to statements and instructions which when executed cause the processor to collect electronic information about the search topic from at least one remote electronic information source over the communication network, and filter the collected information using the set of filter parameters to produce a stream of filtered information;
a memory for packaging the filtered information in discrete information containers;
an output for sending the discrete information containers to the remote user device for display.

16. The system of claim 15, wherein the automated smart agent is trained by monitoring changes performed by a user to output results proposed by the automated smart agent.

17. The system of claim 15, wherein the automated smart agent is trained by comparing information stored in a database with new information arriving at the system and output by the filters.

18. The system of claim 15, wherein the system is adapted to creating a notebook which is empty for the search topic and organizing the filtered electronic information related to the search topic in the notebook.

19. The system of claim 18, wherein the system abbreviates the filtered electronic information of each information container in an information bubble thereby resulting in a list of information bubbles within the notebook.

20. The system of claim 19, wherein the system is adapted to receive a user input representing an acceptance or rejection of one of the information bubbles in the notebook; wherein the automated smart agent is trained by comparing the stream of filtered information, with the rejected information bubbles and the accepted information bubbles.
